(19) United States
(12) Patent Application Publication
(10) Pub. No.: US 2021/0394839 A1
(43) Pub. Date: Dec. 23, 2021

(54) TOWING VEHICLE FOR TRANSPORT DEVICES

(71) Applicant: COBARCO ENTERPRISE PTE. LTD., Singapore (SG)

(72) Inventor: Chih Teng FENG, Singapore (SG)

(21) Appl. No.: 16/908,689

(22) Filed: Jun. 22, 2020

(51) Int. Cl. B62D 55/18; B60K 17/04; B60K 1/04; B60K 17/22; B60D 1/06

(52) U.S. Cl. CPC B62D 55/18; B60K 17/043; B60D 1/06; B60K 17/22; B60K 1/04

(57) ABSTRACT

A towing vehicle for transport devices includes a body, a connection mechanism, a transmission mechanism and a drive mechanism, wherein the front and rear ends of the body are respectively and pivotally installed with track wheels, and each of the track wheels is provided with a second passive gear; the connection mechanism is installed on the body for connecting the towed transport device; the transmission mechanism is installed on both sides of the body, and each of the transmission mechanisms has a primary transmission shaft and two secondary transmission shafts, in which the primary transmission shaft has a first active gear, and the secondary transmission shaft has a second active gear and a first passive gear; moreover, the drive mechanism is used to drive each primary transmission shaft to operate.

### BACKGROUND OF THE INVENTION

### 1. Field of the Invention

The present invention generally relates to a towing vehicle for transport devices; specifically, it relates to a hauling and transporting machine used for towing trailers, camper vans, large containers, ships or aircrafts and other transport devices etc.

### 2. Description of Related Art

It is known that existing transport devices, such as trailers, camper vans, large containers or even ships or aircraft, are towed to the last parking or application location (such as indoor garages, for example) all by means of steerable hauling or transporting vehicles, and to allow such hauling and transporting machines to have good ground gripping force, it is typical to utilize tracks or crawlers for transport operations, and each of the track wheels for driving the track can be individually driven. However, the tonnage of the aforementioned transport devices may not be precisely consistent, and in case that the torque provided by the motor is insufficient, it could be unable to operate smoothly, or even fail to proceed towage operations, and the purpose of transportation cannot be achieved. Therefore, it needs to apply a motor capable of outputting higher torque; but, when multiple motors are upgraded together in this approach, the costs would be inevitably increased and the considerations in terms of development and sales will be greatly challenged.

Consequently, the present invention intends to skillfully focus on the improvement of the transmission configuration, which can be obtained by allowing the motor to output smaller power in exchange for larger torque, and can be altered or modified in accordance with the setup in order to reduce the number of motors used or else to improve the provided torque based on actual demands. Meanwhile, it can also take into account the stability and strength of the structure with respect to the overall transportation equipment during operation, thus illustrating the solution of the towing vehicle for transport devices according to the present invention.

### SUMMARY OF THE INVENTION

A towing vehicle for transport devices according to the present invention is disclosed, comprising: a body, a connection mechanism, a transmission mechanism, a drive mechanism and a support mechanism, wherein the front and rear ends on the two sides of the body are respectively and pivotally installed with a track wheel, each of the track wheels is respectively installed with a second passive gear, and the track wheels located at the two ends on the same side are applied to be conjunctively assembled with a track such that both sides of the body have the tracks available for operation; the connection mechanism has a lifting component installed on the body, in which the top end of the lifting component includes a connection head; the transmission mechanism are respectively installed on the two sides of the body, in which each transmission mechanism is configured with two primary transmission shaft and two secondary transmission shafts, each of the primary transmission shafts is respectively installed with a first active gear, and the secondary transmission shaft has a second active gear and a first passive gear, in which the first active gear is applied to drive the first passive gear and the second active gear is used to drive the second passive gear, and in which the specification of the first active gear is smaller than that of the first passive gear, and the specification of the second active gear is smaller than that of the second passive gear, the first active gear performs transmissions with the first passive gear by means of a transmission component, and the second active gear performs transmissions with the second passive gear also by means of the transmission component; the drive mechanism is fixedly installed within the body, in which the drive mechanism is applied to drive each of the primary transmission shafts to operate; and the support mechanisms are respectively installed on the two sides of the body for supporting the transmission mechanism, in which each of the support mechanisms includes an inner lateral board and an outer lateral board, plural inner holes are openly configured on the inner lateral board, with each of the inner holes being used to enable a sleeve fixation on one end of each of the primary transmission shafts and each of the secondary transmission shafts close to the body, and plural outer holes are openly configured on the outer lateral board, with each of the outer holes being used to enable a sleeve fixation on one end of each of the primary transmission shafts and each of the secondary transmission shafts remote from the body, and in which the bottoms of the inner lateral board and the outer lateral board on the same side are further conjunctively and pivotally provided with a plurality of bottom wheels, with each of the bottom wheels being applied to press against the track that is transmitted to the lower side in order to stabilize the operation of the track.

In a preferred embodiment, the first active gear and the second active gear adopt the same model and the first passive gear and the second passive gear adopt the same model.

In a preferred embodiment, the transmission component uses a belt or a chain.

In a preferred embodiment, a joining device is set up at the joint of the lifting component and the body, and the joining device adopts a universal joint.

In a preferred embodiment, the drive mechanism provides electric power by means of a battery, the body is openly configured with a power supply chamber which is used to accommodate the battery to facilitate the power supply coming from the battery to the drive mechanism.

In a preferred embodiment, a fixed connection component extends from the outer lateral board and is used to be assembled on the inner lateral boards on the same side.

In a preferred embodiment, an upper board and a lower board extend from the outer lateral board, and a fixed connection component forms below the upper board and is used to be assembled at the top ends of the inner lateral boards on the same side.

In a preferred embodiment, plural stoppers are installed above the outer lateral board, and each of such stoppers is used to block and restrict the track so as to prevent outward misalignment issues of the track during its operation.

A towing vehicle for transport devices according to the present invention is disclosed, comprising: a body, a connection mechanism, a transmission mechanism, a drive mechanism and a support mechanism, wherein the front and rear ends on the two sides of the body are respectively and pivotally installed with a track wheel, each of the track wheels is respectively installed with a second passive gear, and the track wheels located at the two ends on the same side are applied to be conjunctively assembled with a track such that both sides of the body have the tracks available for operation; the connection mechanism has a lifting component installed on the body, in which the top end of the lifting component includes a connection head; the transmission mechanisms are respectively installed on the two sides of the body, in which each transmission mechanism is configured with a primary transmission shaft and two secondary transmission shafts, the primary transmission shaft is respectively installed with two first active gears, and each of the secondary transmission shafts has a second active gear and a first passive gear, in which each of the first active gears is respectively applied to drive the first passive gears on the two secondary transmission shafts, and the second active gear is used to drive the second passive gears located at the front and rear ends on the same sides of the body, and in which the specification of the first active gear is smaller than that of the first passive gear, and the specification of the second active gear is smaller than that of the second passive gear, the first active gear performs transmissions with the first passive gear by means of a transmission component, and the second active gear performs transmissions with the second passive gear also by means of the transmission component; the drive mechanism is fixedly installed within the body, in which the drive mechanism is applied to drive each of the primary transmission shafts to operate; and the support mechanisms are respectively installed on the two sides of the body for supporting the transmission mechanism, in which each of the support mechanisms includes an inner lateral board and an outer lateral board, plural inner holes are openly configured on the inner lateral board, with each of the inner holes being used to enable a sleeve fixation on one end of each of the primary transmission shafts and each of the secondary transmission shafts close to the body, and plural outer holes are openly configured on the outer lateral board, with each of the outer holes being used to enable a sleeve fixation on one end of each of the primary transmission shafts and each of the secondary transmission shafts remote from the body, and in which the bottoms of the inner lateral board and the outer lateral board on the same side are further conjunctively and pivotally provided with a plurality of bottom wheels, with each of the bottom wheels being applied to press against the track that is transmitted to the lower side in order to stabilize the operation of the track.

A towing vehicle for transport devices according to the present invention is disclosed, comprising: a body, a connection mechanism, a transmission mechanism, a drive mechanism and a support mechanism, wherein the front and rear ends on the two sides of the body are respectively and pivotally installed with a track wheel, each of the track wheels is respectively installed with a second passive gear, and the track wheels located at the two ends on the same side are applied to be conjunctively assembled with a track such that both sides of the body have the tracks available for operation; the connection mechanism has a lifting component installed on the body, in which the top end of the lifting component includes a connection head; the transmission mechanisms are respectively installed on the two sides of the body, in which the transmission mechanism is configured with two primary transmission shafts and four secondary transmission shafts, each of the primary transmission shafts is respectively installed with a first active gear, and each of the secondary transmission shafts has a second active gear and a first passive gear, in which one of the first active gears is applied to drive one of the first passive gears which then drives the second active gear located on the same secondary transmission shaft to rotate, and such a secondary active gear then further drive another first passive gear; in addition, another first passive gear drives the second active gear located on the same secondary transmission shaft to rotate, and then this second active gear further drives one of the second passive gears, and in which the specification of the first active gear is smaller than that of the first passive gear, the specification of the second active gear is smaller than that of the second passive gear, the first active gear performs transmissions with the first passive gear by means of a transmission component, and the second active gear performs transmissions with the second passive gear also by means of the transmission component; the drive mechanism is fixedly installed within the body, in which the drive mechanism is applied to drive each of the primary transmission shafts to operate; and the support mechanisms are respectively installed on the two sides of the body for supporting the transmission mechanism, in which each of the support mechanisms includes an inner lateral board and an outer lateral board, plural inner holes are openly configured on the inner lateral board, with each of the inner holes being used to enable a sleeve fixation on one end of each of the primary transmission shafts and each of the secondary transmission shafts close to the body, and plural outer holes are openly configured on the outer lateral board, with each of the outer holes being used to enable a sleeve fixation on one end of each of the primary transmission shafts and each of the secondary transmission shafts remote from the body, and in which the bottoms of the inner lateral board and the outer lateral board on the same side are further conjunctively and pivotally provided with a plurality of bottom wheels, with each of the bottom wheels being applied to press against the track that is transmitted to the lower side in order to stabilize the operation of the track.

### BRIEF DESCRIPTION OF THE DRAWINGS

FIG. 1 shows an overall structural stereo disassembled view of the towing vehicle for transport devices according to the present invention.

FIG. 2 shows an overall structural stereo view of the towing vehicle for transport devices according to the present invention.

FIG. 3 shows a partial structural cross-sectioned view of the towing vehicle for transport devices according to the present invention.

FIG. 4 shows a planar view for an implemented towage of the towing vehicle for transport devices according to the present invention.

FIG. 5 shows a planar view for a first embodiment of the transmission mechanism in the towing vehicle for transport devices according to the present invention.

FIG. 6 shows a planar view for a second embodiment of the transmission mechanism in the towing vehicle for transport devices according to the present invention.

FIG. 7 shows a planar view for a third embodiment of the transmission mechanism in the towing vehicle for transport devices according to the present invention.

### DETAILED DESCRIPTION OF THE PREFERRED EMBODIMENTS

Other technical contents, aspects and effects in relation to the present invention can be clearly appreciated through the detailed descriptions concerning the preferred embodiments of the present invention in conjunction with the appended drawings.

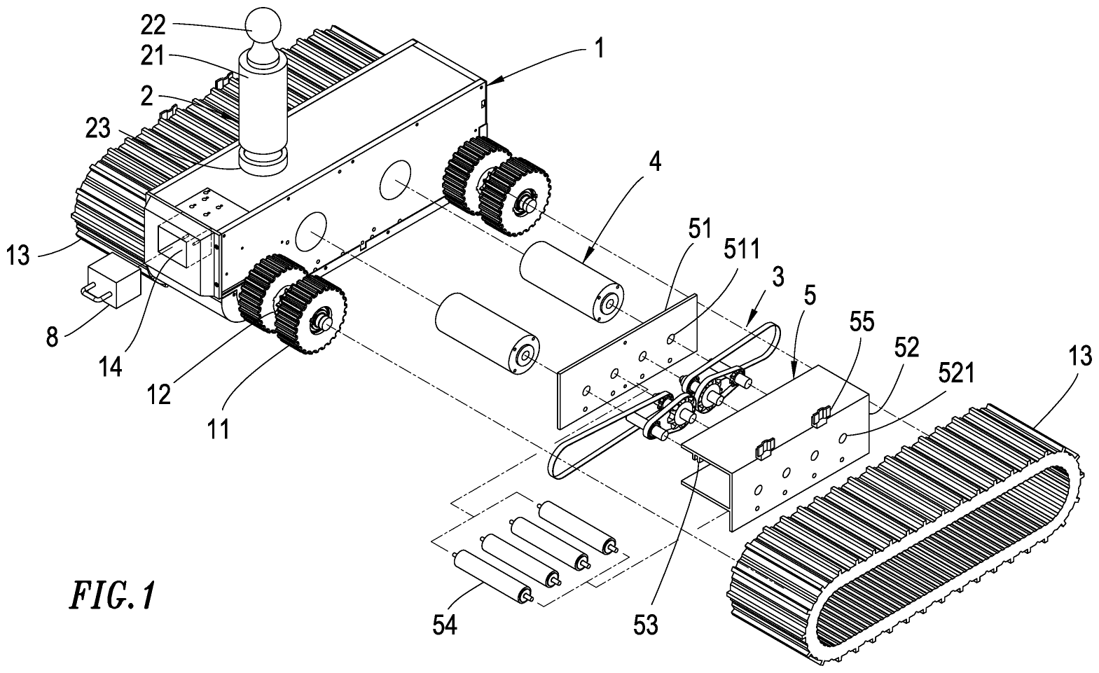

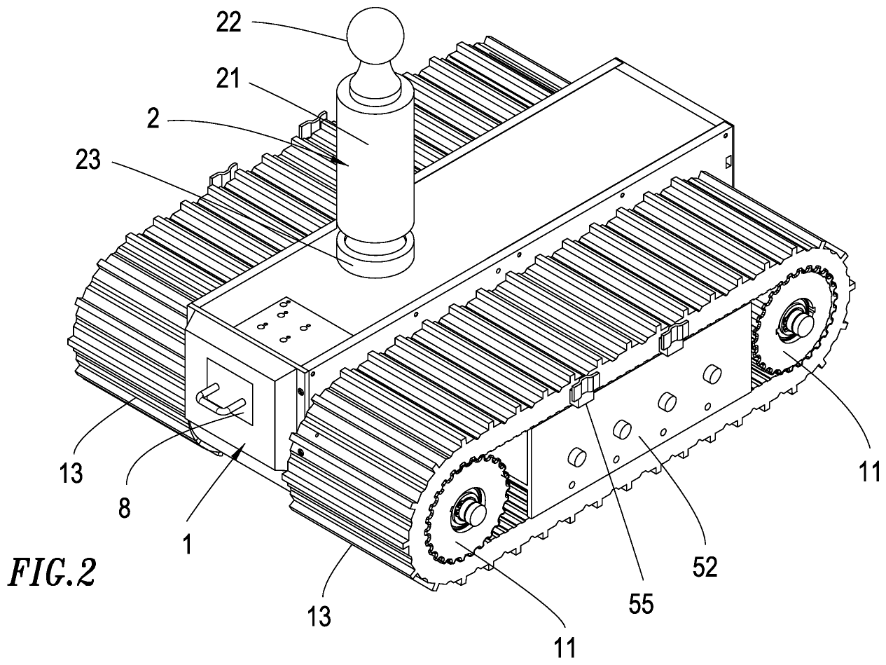

Refer first to FIGS. 1-2, the stereo views of the towing vehicle for transport devices according to the present invention are respectively shown, comprising a body 1, a connection mechanism 2, a transmission mechanism 3, a drive mechanism and a support mechanism 5.

Herein the front and rear ends on the two sides of the body 1 are respectively and pivotally installed with a track wheel 11, each of the track wheels 11 is respectively installed with a second passive gear 12, and the track wheels 11 located at the two ends on the same side are applied to be conjunctively assembled with a track 13 such that both sides of the body 1 have the tracks 13 available for operation.

Herein the connection mechanism 2 has a lifting component 21 installed on the body 1, in which the top end of the lifting component 21 includes a connection head 22; in the present embodiment, a joining mechanism 23 is set up at the joint of the lifting component 21 and the body 1, and the joining mechanism 23 adopts a universal joint.

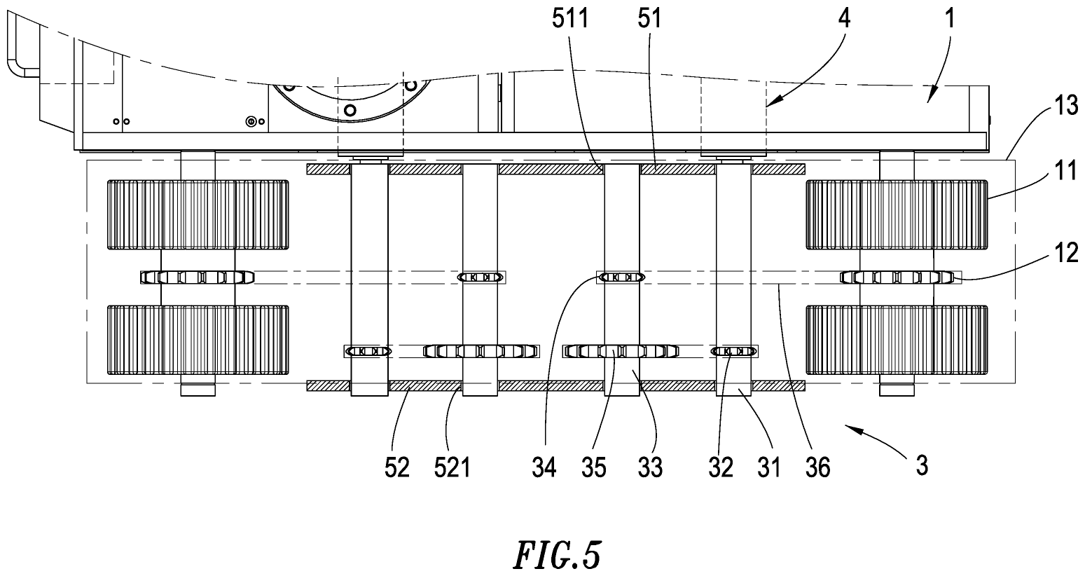

In addition, referring conjunctively to FIG. 5, herein the transmission mechanisms 3 are respectively installed on the two sides of the body 1, in which each transmission mechanism 3 is configured with at least one primary transmission shaft 31 and at least two secondary transmission shafts 33, the primary transmission shaft has at least one first active gear 32, and the secondary transmission shaft 33 has a second active gear 34 and a first passive gear 35, in which the first active gear 32 is applied to drive the first passive gear 35 and the second active gear 34 is used to drive the second passive gear 12, and in which the specification of the first active gear 32 is smaller than that of the first passive gear 35, and the specification of the second active gear 34 is smaller than that of the second passive gear 12.

Also, herein the drive mechanism 4 is fixedly installed within the body 1, in which the drive mechanism 4 is applied to drive each of the primary transmission shafts 31 to operate.

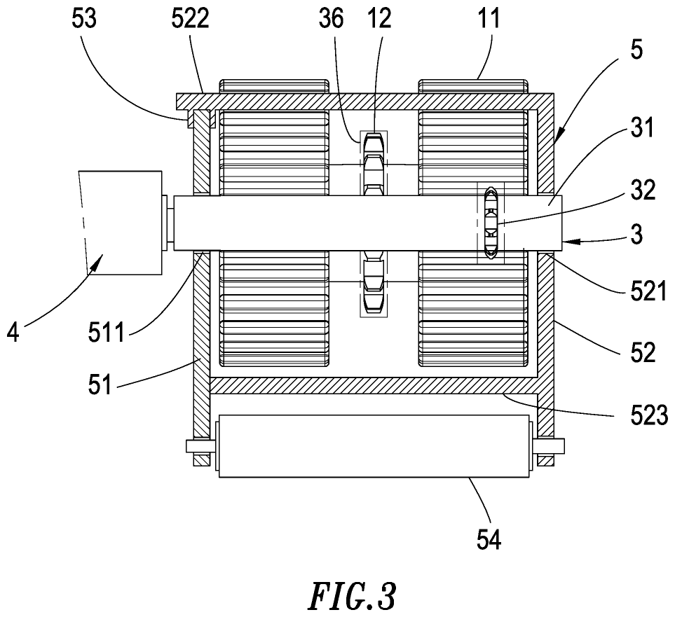

Moreover, referring to FIG. 3, the support mechanism 5 is respectively installed on the two sides of the body 1 for supporting the transmission mechanism 3, in which each of the support mechanisms 5 includes an inner lateral board 51 and an outer lateral board 52, plural inner holes 511 are openly configured on the inner lateral board 51, with each of the inner holes 511 being used to enable a sleeve fixation on one end of each of the primary transmission shafts 31 and each of the secondary transmission shafts 33 close to the body 1, and plural outer holes 521 are openly configured on the outer lateral board 52, with each of the outer holes 521 being used to enable a sleeve fixation on one end of each of the primary transmission shafts 31 and each of the secondary transmission shafts 33 remote from the body 1; besides, a fixed connection component 53 extends from the outer lateral board 52 and is used to be assembled on the inner lateral boards 51 on the same side; also, the bottoms of the inner lateral board 51 and the outer lateral board 52 on the same side are further conjunctively and pivotally provided with a plurality of bottom wheels 54, with each of the bottom wheels 54 being applied to press against the track 13 that is transmitted to the lower side in order to stabilize the operation of the track 13.

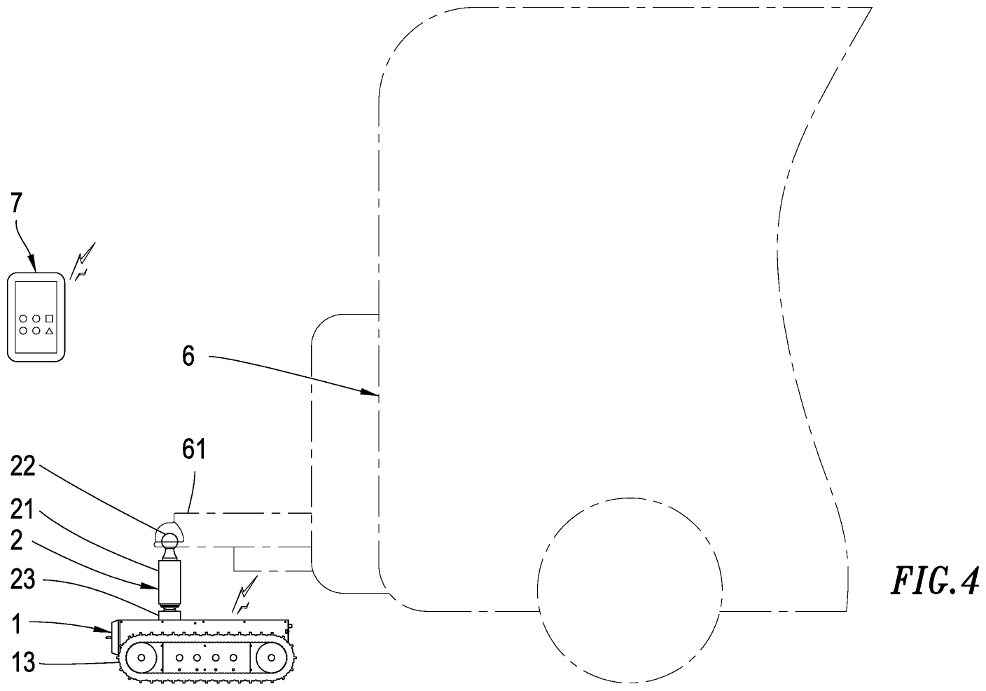

Refer to FIGS. 1-4, the towing vehicle for transport devices according to the present invention combines the connection end 61 of a transport device 6 with the connection head 22, and the above-said transport device 6 may be a trailer, a camper van or a large container truck, or even a boat or an aircraft, so that it is possible to remotely control the drive mechanism 4 by means of a control device 7 in order to drive the track 13 to operate thereby further dragging the transport device 6 to a designated position. The control device 7 may be a mobile device such as a mobile phone, a tablet computer, or a remote controller.

Regarding to the transmission mechanism 3 that transmits the track 13, the following three implementation configurations and settings are respectively described in detail to illustrate the operations and effects:

Refer first to FIGS. 1-3 and 5, a first embodiment is shown, and it can be observed that, in this embodiment, the transmission mechanism 3 is configured with two primary transmission shafts 31 and two secondary transmission shafts 33, each of the primary transmission shafts 31 is respectively provided with a first active gear 32, and when each of the primary transmission shafts 31 is driven, one of the first active gears 32 drives one of the first passive gears 35, and the first passive gear 35 drives the second active gear 34 located on the same secondary transmission shaft 33 to rotate. Next, the second active gear 34 can drive one of the second passive gears 12 again; i.e., the other end on the same side of the body 1 and both ends on the other side are of the same configuration, while each of the primary transmission shafts 31 is respectively driven by one drive mechanism 4, such that, when each drive mechanism 4 is controlled to operate synchronously and at the same speed, each second passive gear 12 can be driven separately, and the track wheels 11 located at the two ends on the same side of the body 1 can operate synchronously and at the same speed, thus further driving the track 13. Meanwhile, the transmission mechanism 3 located on the other side of the body 1 also operates based on the same configuration, and since the specification of the first active gear 32 is smaller than that of the first passive gear 35 and the specification of the second active gear 34 is smaller than the second passive gear 12, it can be seen that, not only a greater torque can be obtained in exchange of the deceleration during transmissions, but it is increased to at least three times the original torque by means of two decelerations.

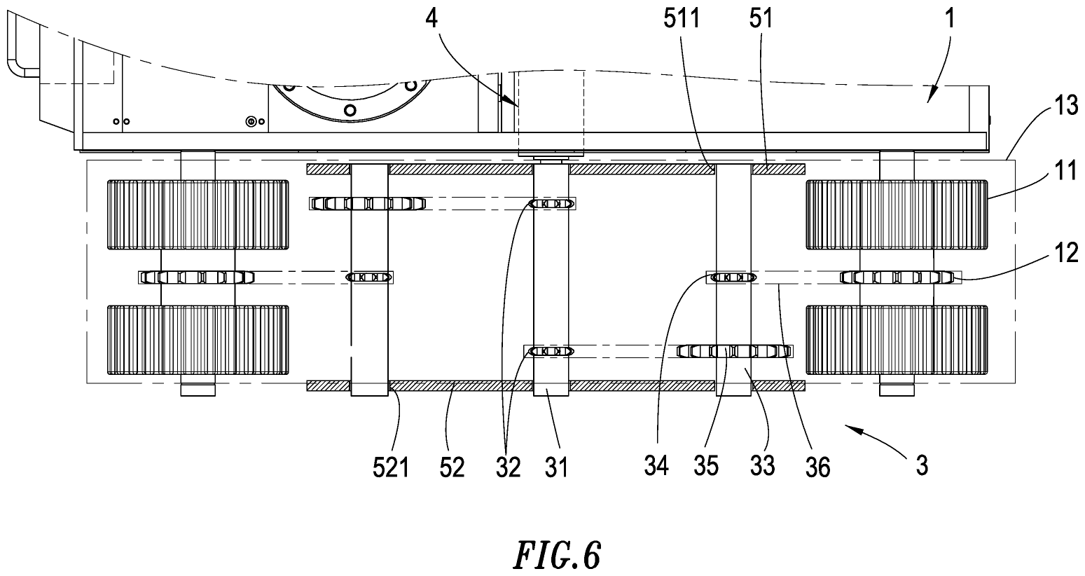

Refer to FIG. 6, a second embodiment is shown, and it can be observed that, in this embodiment, the drive mechanism 4 is configured to be combined together and the transmission mechanism 3 include a primary transmission shaft 31 and two secondary transmission shafts 33, the primary transmission shaft 31 is provided with two first active gear 32, and when the primary transmission shaft 31 is driven, one of the first active gears 32 drives one of the first passive gears 35, and the first passive gear 35 drives the second active gear 34 located on the same secondary transmission shaft 33 to rotate. Next, the second active gear 34 can drive one of the second passive gears 12 again; i.e., the other first active gear 32 drives the other first passive gear 35, and the first passive gear 35 drives the second active gear 34 located on the same secondary transmission shaft 33 to rotate, and then the second active gear 34 can drive another second passive gear 12, and the primary transmission shaft 31 is driven by the drive mechanism 4 thereby further driving the track 13. Meanwhile, the transmission mechanism 3 located on the other side of the body 1 also operates based on the same configuration, and since the specification of the first active gear 32 is smaller than that of the first passive gear 35 and the specification of the second active gear 34 is smaller than the second passive gear 12, it can be seen that, not only a greater torque can be obtained in exchange of the deceleration during transmissions, but it is increased to at least three times the original torque by means of two decelerations.

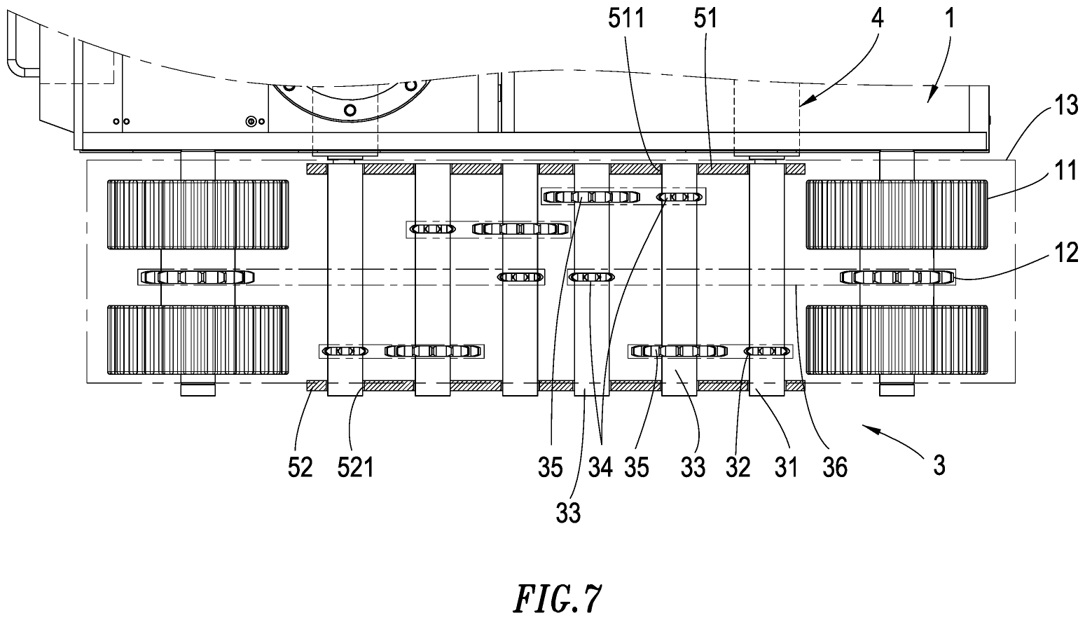

Now refer to FIG. 7, a third embodiment of the present invention is shown and indicates an improved version of the first embodiment. It can be appreciated that a secondary transmission shaft 33 is newly added respectively to both ends on the same side of the body 1, so the transmission mechanism 3 is configured with two primary transmission shafts 31 and four secondary transmission shafts 33. Each primary transmission shaft 31 is respectively installed with a first active gear 32, and when each primary transmission shaft 31 is driven, one of the first active gears 32 drives one of the first passive gears 35, and the first passive gear 35 further drives the second active gear 34 located on the same secondary transmission shaft 33 to rotate, and this secondary active gear 34 can further drive another first passive gear 35, while another first passive gear 35 drives the second active gear 34 located on the same secondary transmission shaft 33 to rotate, and this second active gear 34 further drives one of the second passive gear 13; in other words, the other end of the same side and the two ends of the other side of the body 1 have the same configuration, and each primary transmission shaft 31 is respectively driven by one drive mechanism 4, so that, when each drive mechanism 4 is controlled synchronously and at the same speed during the operation, the second passive gear 12 can be driven separately, and the track wheels 11 at the two ends on the same side of the body 1 can operate synchronously and at the same speed, thereby driving the track 13. Meanwhile, the transmission mechanism 3 located on the other side of the body 1 also operates based on the same configuration, and since the specification of the first active gear 32 is smaller than that of the first passive gear 35 and the specification of the second active gear 34 is smaller than the first passive gear 35 and the second passive gear 12, it can be seen that, not only a greater torque can be obtained in exchange of the deceleration during transmissions, but it is increased to at least four times the original torque or more by means of three decelerations.

It should be noticed that, in the aforementioned first, second and third embodiments, the first active gear 32 and the second active gear 34 adopt the same model, the first passive gear 35 and the second passive gear 12 adopt the same model, and each drive mechanism 4 adopts the same model as well.

In the first, second and third embodiments described above, the first active gear 32 performs transmissions with the first passive gear 35 by means of a transmission component 36, and the second active gear 34 performs transmissions with the first passive gear 35 or the second passive gear 12 also by means of the transmission component 36. The transmission component 36 may adopt a belt or a chain.

In the towing vehicle for transport devices according to the present invention, referring to FIGS. 1-2, the drive mechanism 4 can acquire electric power by connecting to the city power grid, and it is also possible to use a battery 8 to provide electric power to the drive mechanism 4, in which the battery 8 can be fully charged and prepared in advance, and replaced when necessary. Additionally, the body 1 can be openly configured with a power supply chamber 14 for accommodating the battery 8 to facilitate power supply to the drive mechanism 4.

Furthermore, referring to FIG. 3, in the present embodiment of the towing vehicle for transport devices according to the present invention, an upper board 522 and a lower board 523 extend from the outer lateral board 52 and form a “C” shape, and the fixed connection component 53 is formed below the upper board 522 so as to be assembled on the upper end of the inner lateral board 51. Moreover, referring to FIGS. 1-2, a plurality of stoppers 55 are set up over the outer lateral board 52, and each of such stoppers 55 is applied to block and restrict the track 13 in order to prevent outward misalignment issues of the track 13 during operation.

The previously disclosed embodiments are merely illustrative of some preferred ones of the present invention, which are not intended to limit the scope thereof; those who are skilled in the relevant technical fields can, after understanding the technical features and embodiments of the present invention as explained hereinabove, certainly make equivalent changes, alterations or modifications without departing from the spirit and scope of the present invention, which are nonetheless deemed as falling within the coverage of the present invention; accordingly, the scope of the present invention to be protected by patent laws is subject to the definition of the claims attached to this specification.

What is claimed is:

1. A towing vehicle for a transport device, comprising:
a body, in which the front and rear ends on the two sides of the body are respectively and pivotally installed with a track wheel, each of the track wheels is respectively installed with a second passive gear, and the track wheels located at the two ends on the same side are applied to be conjunctively assembled with a track;
a connection mechanism, having a lifting component installed on the body, in which the top end of the lifting component includes a connection head;
a transmission mechanism, respectively installed on the two sides of the body, in which each transmission mechanism is configured with two primary transmission shaft and two secondary transmission shafts, each of the primary transmission shafts is respectively installed with a first active gear, and the secondary transmission shaft has a second active gear and a first passive gear, in which the first active gear is applied to drive the first passive gear and the second active gear is used to drive the second passive gear, and in which the specification of the first active gear is smaller than that of the first passive gear, and the specification of the second active gear is smaller than that of the second passive gear, the first active gear performs transmissions with the first passive gear by means of a transmission component, and the second active gear performs transmissions with the second passive gear also by means of the transmission component;
a drive mechanism, fixedly installed within the body, in which the drive mechanism is applied to drive each of the primary transmission shafts to operate; and
a support mechanism, respectively installed on the two sides of the body for supporting the transmission mechanism, in which each of the support mechanisms includes an inner lateral board and an outer lateral board, plural inner holes are openly configured on the inner lateral board, with each of the inner holes being used to enable a sleeve fixation on one end of each of the primary transmission shafts and each of the secondary transmission shafts close to the body, and plural outer holes are openly configured on the outer lateral board, with each of the outer holes being used to enable a sleeve fixation on one end of each of the primary transmission shafts and each of the secondary transmission shafts remote from the body, and in which the bottoms of the inner lateral board and the outer lateral board on the same side are further conjunctively and pivotally provided with a plurality of bottom wheels, with each of the bottom wheels being applied to press against the track that is transmitted to the lower side in order to stabilize the operation of the track.

2. The towing vehicle for a transport device according to claim 1, wherein the first active gear and the second active gear adopt the same model and the first passive gear and the second passive gear adopt the same model.

3. The towing vehicle for a transport device according to claim 1, wherein the transmission component uses a belt or a chain.

4. The towing vehicle for a transport device according to claim 1, wherein a joining device is set up at the joint of the lifting component and the body, and the joining device adopts a universal joint.

5. The towing vehicle for a transport device according to claim 1, wherein the drive mechanism provides electric power by means of a battery, the body is openly configured with a power supply chamber which is used to accommodate the battery to facilitate the power supply coming from the battery to the drive mechanism.

6. The towing vehicle for a transport device according to claim 1, wherein a fixed connection component extends from the outer lateral board and is used to be assembled on the inner lateral boards on the same side.

7. The towing vehicle for a transport device according to claim 1, wherein an upper board and a lower board extend from the outer lateral board, and a fixed connection component forms below the upper board and is used to be assembled at the top ends of the inner lateral boards on the same side.

8. The towing vehicle for a transport device according to claim 1, wherein plural stoppers are installed above the outer lateral board, and each of such stoppers is used to block and restrict the track so as to prevent outward misalignment issues of the track during its operation.

9. A towing vehicle for a transport device, comprising:
a body, in which the front and rear ends on the two sides of the body are respectively and pivotally installed with a track wheel, each of the track wheels is respectively installed with a second passive gear, and the track wheels located at the two ends on the same side are applied to be conjunctively assembled with a track;
a connection mechanism, having a lifting component installed on the body, in which the top end of the lifting component includes a connection head;
a transmission mechanism, respectively installed on the two sides of the body, in which each transmission mechanism is configured with a primary transmission shaft and two secondary transmission shafts, the primary transmission shaft is respectively installed with two first active gears, and each of the secondary transmission shafts has a second active gear and a first passive gear, in which each of the first active gears is respectively applied to drive the first passive gears on the two secondary transmission shafts, and the second active gear is used to drive the second passive gears located at the front and rear ends on the same sides of the body, and in which the specification of the first active gear is smaller than that of the first passive gear, and the specification of the second active gear is smaller than that of the second passive gear, the first active gear performs transmissions with the first passive gear by means of a transmission component, and the second active gear performs transmissions with the second passive gear also by means of the transmission component;
a drive mechanism, fixedly installed within the body, in which the drive mechanism is applied to drive each of the primary transmission shafts to operate; and
a support mechanism, respectively installed on the two sides of the body for supporting the transmission mechanism, in which each of the support mechanisms includes an inner lateral board and an outer lateral board, plural inner holes are openly configured on the inner lateral board, with each of the inner holes being used to enable a sleeve fixation on one end of each of the primary transmission shafts and each of the secondary transmission shafts close to the body, and plural outer holes are openly configured on the outer lateral board, with each of the outer holes being used to enable a sleeve fixation on one end of each of the primary transmission shafts and each of the secondary transmission shafts remote from the body, and in which the bottoms of the inner lateral board and the outer lateral board on the same side are further conjunctively and pivotally provided with a plurality of bottom wheels, with each of the bottom wheels being applied to press against the track that is transmitted to the lower side in order to stabilize the operation of the track.

10. A towing vehicle for a transport device, comprising:
a body, in which the front and rear ends on the two sides of the body are respectively and pivotally installed with a track wheel, each of the track wheels is respectively installed with a second passive gear, and the track wheels located at the two ends on the same side are applied to be conjunctively assembled with a track;
a connection mechanism, having a lifting component installed on the body, in which the top end of the lifting component includes a connection head;
a transmission mechanism, respectively installed on the two sides of the body, in which the transmission mechanism is configured with two primary transmission shafts and four secondary transmission shafts, each of the primary transmission shafts is respectively installed with a first active gear, and each of the secondary transmission shafts has a second active gear and a first passive gear, in which one of the first active gears is applied to drive one of the first passive gears which then drives the second active gear located on the same secondary transmission shaft to rotate, and such a secondary active gear then further drive another first passive gear;
in addition, another first passive gear drives the second active gear located on the same secondary transmission shaft to rotate, and then this second active gear further drives one of the second passive gears, and in which the specification of the first active gear is smaller than that of the first passive gear, the specification of the second active gear is smaller than that of the second passive gear, the first active gear performs transmissions with the first passive gear by means of a transmission component, and the second active gear performs transmissions with the second passive gear also by means of the transmission component;
a drive mechanism, fixedly installed within the body, in which the drive mechanism is applied to drive each of the primary transmission shafts to operate; and
a support mechanism, respectively installed on the two sides of the body for supporting the transmission mechanism, in which each of the support mechanisms includes an inner lateral board and an outer lateral board, plural inner holes are openly configured on the inner lateral board, with each of the inner holes being used to enable a sleeve fixation on one end of each of the primary transmission shafts and each of the secondary transmission shafts close to the body, and plural outer holes are openly configured on the outer lateral board, with each of the outer holes being used to enable a sleeve fixation on one end of each of the primary transmission shafts and each of the secondary transmission shafts remote from the body, and in which the bottoms of the inner lateral board and the outer lateral board on the same side are further conjunctively and pivotally provided with a plurality of bottom wheels, with each of the bottom wheels being applied to press against the track that is transmitted to the lower side in order to stabilize the operation of the track.
